(19) United States
(12) Patent Application Publication
(10) Pub. No.: US 2007/0247771 A1
(43) Pub. Date: Oct. 25, 2007

(54) Analog Input/Output Circuit with ESD Protection

(75) Inventor: Te-Wei Chen, Chupei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: SILICONMOTION INC., Jhubei City (TW)

(21) Appl. No.: 11/534,244

(22) Filed: Sep. 22, 2006

(30) Foreign Application Priority Data
Apr. 25, 2006 (TW) 95114781

(51) Int. Cl. H02H 9/00

(52) U.S. Cl. 361/56

(57) ABSTRACT

An analog input/output (I/O) circuit contains a pad, an analog IP (Intellectual Property) circuit, and a transmission gate. The pad is connected to the analog circuit IP. The transmission gate is configured between the pad and analog circuit IP, and therefore any signal between the pad and analog circuit IP must pass through the transmission gate. In normal operation, the transmission gate allows analog signals to transfer between the pad and analog circuit IP. If an ESD (Electrostatic Discharge) current is induced from the pad, the transmission gate discharges the current and protects the analog circuit IP.

### RELATED APPLICATIONS

The present application is based on, and claims priority from, Taiwan Application Serial Number 95114781, filed Apr. 25, 2006, the disclosure of which is hereby incorporated by reference herein in its entirety.

### BACKGROUND

1. Field of Invention

The present invention relates to a protection circuit. More particularly, the present invention relates to a protection circuit for electrostatic discharge in an analog input/output circuit.

2. Description of Related Art

Electrostatic discharge (ESD) protection circuits are very important in circuit IP (Intellectual Property) design. Environmental static electricity voltages may exceed thousands of volts. If their special protective design is not integrated into the input/output circuit, the high ESD current very quickly penetrates the internal circuit IP, and damages the internal circuit IP. So, to protect the internal circuit IP and improve the reliability of the electronics, an ESD protection circuit must be configured into an input/output circuit.

The conventional ESD protection circuit is usually configured between the pad and circuit IP in an I/O (input/output) circuit. In normal operations, the conventional ESD protection circuit is in an off state. When high ESD current is induced from the pad, the ESD protection circuit discharges the high ESD current to a ground and protects the internal circuit IP.

FIG. 1 is a schematic diagram of a conventional digital I/O circuit 100. The ESD protection circuit 104 contains a P-type metal-oxide semiconductor 110 and an N-type metal-oxide semiconductor 112. The N-type metal-oxide semiconductor 112 gate is grounded, and the P-type metal-oxide semiconductor 110 gate is biased. In normal operations, the ESD protection circuit 104 is in an off state, and does not influence the I/O signal. If an ESD current is induced from the pad 102, the parasitic lateral bipolar transistor of the metal-oxide semiconductor 110 and 112 is activated, and the parasitic lateral bipolar transistor of the metal-oxide-semiconductors 110 and 112 discharges the ESD current.

The conventional digital I/O circuit 100 in the FIG. 1 further comprises an inverter 106; the inverter 106 is a buffer for the digital circuit IP 108. The inverter 106 contains an N-type metal-oxide semiconductor 116 and a P-type metal-oxide semiconductor 114. If the input digital signal has changes slightly, after passing through the inverter 106, the inverter 106 revises the input digital signal. The digital signal from the pad 102 to the digital circuit IP 108 must pass through the inverter 106.

Sometimes if the ESD current is induced too quickly and the parasitic lateral bipolar transistor in the metal-oxide semiconductors 110 and 112 is activated too late. Therefore the ESD protection circuit 104 in effect does not exist. The ESD current then destroys the gate of the inverter 106 directly. To prevent the ESD current from destroying the gate of the inverter 106, the digital I/O circuit 100 can strengthen the inverter 106 if the layout conditions permit.

FIG. 2 is a schematic diagram of a conventional analog I/O circuit 200. Referring to FIG. 1 and FIG. 2, the conventional analog I/O circuit 200 does not use a device as an inverter 106. The analog I/O circuit 200 receives an analog signal, and the analog signal must flow into the analog I/O circuit 200. The analog signal therefore cannot pass through the device like inverter 106.

Because the conventional analog I/O circuit 200 does not have a device like inverter 106. To prevent ESD current from being induced too fast and the ESD protection circuit 204 from being activated too late, the ESD protection of the analog circuit IP 206 itself must be strengthened. But if the analog circuit IP ESD protection is strengthened, only a specific device or layout design can be used, and the degree of design difficulty and cost increases.

In conclusion, it is a target on ESD protection design to improve analog I/C circuit ESD protection and allowing the analog circuit IP design to be more flexible about using devices and layout design.

### SUMMARY

It is therefore an objective of the present invention to provide an analog I/O protection circuit, which can let the analog circuit IP designer be flexible about using devices and layout design.

In accordance with the foregoing and other objectives of the present invention, an analog I/O circuit thereof is provided. The analog I/O circuit comprises a pad, an analog circuit IP and a transmission gate. One side of the transmission gate is electrically connected to the pad and another side is electrically connected to the analog circuit IP, wherein the transmission gate at least comprises a gate biased first N-type metal-oxide semiconductor and a gate grounded first P-type metal-oxide semiconductor. The N-type and P-type metal-oxide-semiconductors are connected in parallel. When the ESD current is induced from the PAD, the transmission gate can discharge the current and protect the analog circuit IP.

The advantage of the transmission gate is that any signal transfer between the pad and the analog circuit IP has no influence during normal operation. When the ESD current is induced, the transmission gate discharges the ESD current. Because of the transmission gate structure, the ESD current must pass through the transmission gate. The ESD protection design of an analog I/O circuit only considers the ESD protection level of the transmission gate. This invention both reduces the degree of design difficulty for analog circuit IP and allows the analog circuit IP designer to be flexible in the use of devices and/or layout design.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention become better understood with regard to the following description, appended claims, and accompanying drawings where:

FIG. 1 is a schematic diagram of a conventional digital I/O circuit;

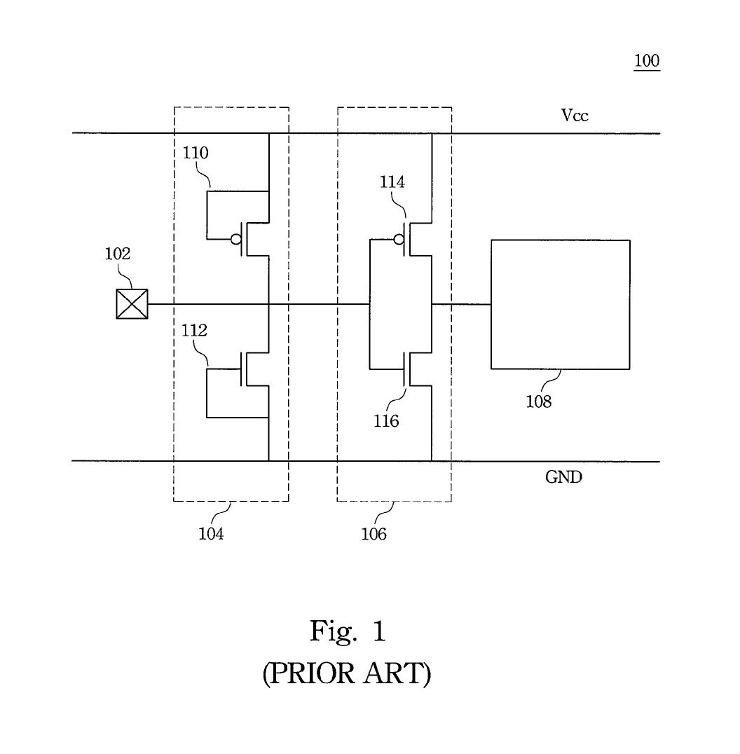

FIG. 2 is a schematic diagram of a conventional analog I/O circuit;

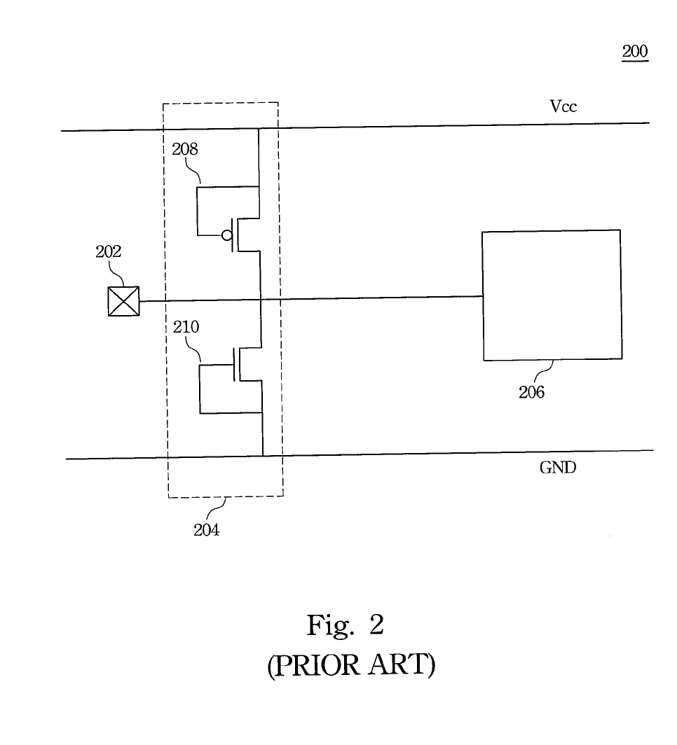

FIG. 3 is a schematic diagram of an analog I/O circuit of one preferred embodiment in the present invention;

FIG. 4 is a schematic diagram of an analog I/O circuit of another preferred embodiment in the present invention.

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

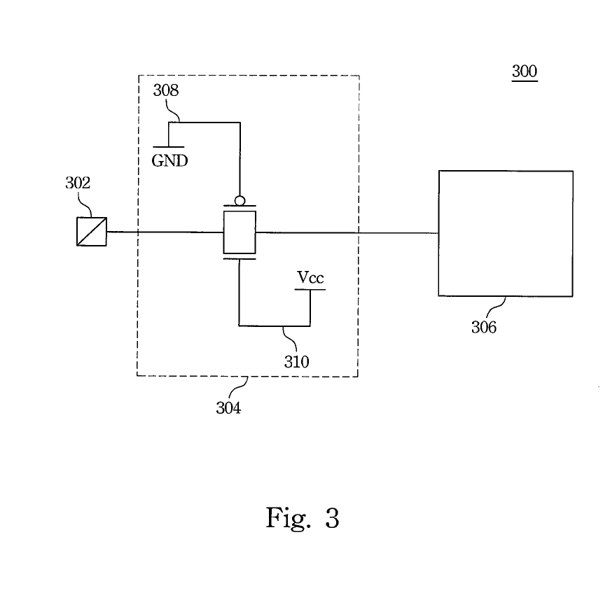

FIG. 3 is a schematic diagram of an analog I/O circuit of one preferred embodiment in the present invention. As illustrated in FIG. 3, the analog I/O circuit 300 has a pad 302, an analog circuit IP 306 and a transmission gate 304. The analog circuit IP 306 is electrically connected to the pad 302 and the transmission gate 304 is configured between the pad 302 and the analog circuit IP 306. In normal operations, the transmission gate 304 is in a transmitting state. Any signal can pass through the transmission gate 304 uninfluenced. When an induced ESD current is present, the transmission gate 304 discharges the ESD current, and protects the analog circuit IP 306. The ESD current must pass through the transmission gate 304, and the conventional ESD protection circuit problems of ESD currents being induced too quickly and the parasitic lateral bipolar transistor being activated too late to discharge the ESD current is impossible. So the design of the analog circuit IP 304 is not considered to have an ESD problem, and only enhances the ESD protection level on the transmission gate 304.

The transmission gate 304 in this embodiment comprises a gate biased first N-type metal-oxide semiconductor 310 and a gate grounded first P-type metal-oxide semiconductor 308 connected in parallel. The drain and source of the metal-oxide semiconductor 308 and 310 are connected to the pad 302 and the analog circuit IP 306 separately. In normal operations the first N-type metal-oxide semiconductor 310 and first P-type metal-oxide semiconductor 308 are conducted, any signal transfers between the pad 302 and the analog circuit IP 306 have no influence. The metal-oxide semiconductors 308 and 310 work in their linear region and can be used as a resistance. In other words, the transmission gate 306 is a resistance and configured between the pad 302 and the analog circuit IP 306 during normal operation. When an induced ESD current is present the transmission gate 306 works as a conventional ESD protection circuit, and discharges the ESD current.

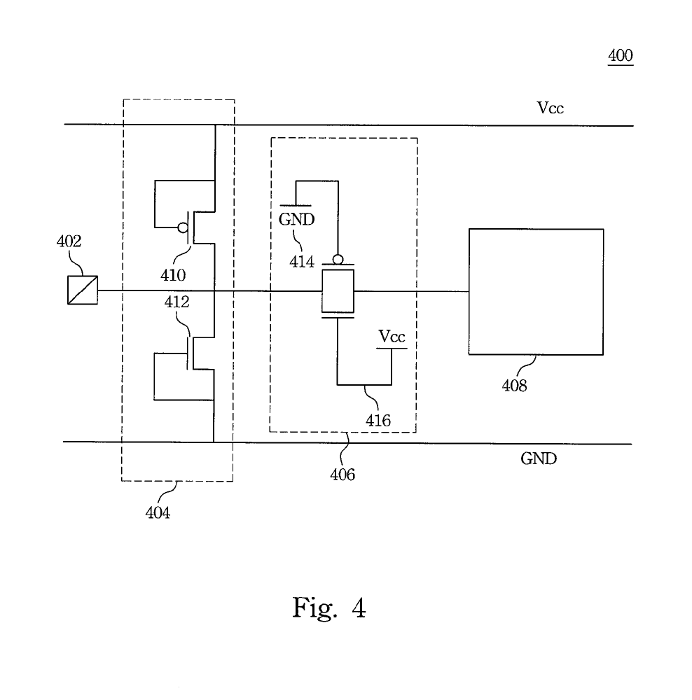

FIG. 4 is a schematic diagram of an analog I/O circuit 400 of another preferred embodiment of the present invention. In this embodiment the ESD protection circuit 404 is configured between the pad 402 and the transmission gate 406. The ESD protection circuit 404 in this embodiment comprises a drain biased second P-type metal-oxide semiconductor 410 and a gate and drain grounded second N-type metal-oxide semiconductor 412. When the ESD current is induced from the pad, the parasitic lateral bipolar transistor of the metal-oxide semiconductor 410 and 412 can discharge the ESD current to ground.

If the ESD current is induced too fast to activate the ESD protection circuit 404, the ESD current passes through the transmission gate 406, and is discharged to the ground by the transmission gate 406. The transmission gate 406 in this embodiment comprises a gate biased first N-type metal-oxide semiconductor 416 and a gate grounded first P-type metal-oxide semiconductor 414 connected in parallel. The drain and source of the metal-oxide semiconductor 416 and 414 are connected to the pad and analog circuit IP separately. In normal operations the first N-type metal-oxide semiconductor 416 and first P-type metal-oxide semiconductor 414 are conductors. Any signal transfers between the pad 402 and the analog circuit IP 408 have no influence. The metal-oxide semiconductors 414 and 416 work in their linear region and can be used as a resistor, in other words, the transmission gate 404 is a resistance and configured between the pad 402 and analog circuit IP 408 during normal operation. When an induced ESD current is present the transmission gate 406 works as a conventional ESD protection circuit and discharges the ESD current.

So that, apart from having the ESD protection circuit 404 configured in the analog I/O circuit 400, the analog I/O circuit 400 also has a transmission gate 406 configured between the ESD protection circuit 404 and the analog circuit IP 408. When the ESD current is induced too fast and the ESD protection circuit 404 is activated too late, the transmission gate 406 discharges the ESD current, and protect the analog circuit IP 408 completely.

It is to be understood that the ESD current must be passing through the transmission gate, so that the problem of conventional ESD protection circuit of having an ESD current being induced too fast and the ESD protection circuit being activated too late to discharge the ESD current is impossible. The transmission gate in normal operation can be used as a resistor. The signal transfers between the pad and the analog circuit IP have no influence. When is an induced ESD current as in the present embodiment, the transmission gate discharges the ESD current, and protects the analog circuit IP. The degree of design difficulty of an analog circuit IP is reduced and the analog circuit IP design can be flexible about using devices and layout design.

It is apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An analog input/output circuit, comprising:
a pad;
an analog circuit IP; and
a transmission gate, one side electrically connected to the pad and another side electrically connected to the analog circuit IP, wherein the transmission gate at least comprises a gate biased first N-type metal-oxide semiconductor and a gate grounded first P-type metal-oxide semiconductor connected in parallel to each other, and the transmission gate is capable of transmitting a signal that has no influence, when an incoming ESD current is present, the transmission gate can discharge the ESD current, and protect the analog circuit IP.

2. The analog input/output circuit of claim 1, wherein the gate grounded first N-type metal-oxide semiconductor is connected to a bias and the source and drain are separately electrically connected to the pad and the analog circuit IP, and is capable of transmitting a signal with no influence between the pad and the analog circuit IP.

3. The analog input/output circuit of claim 1, wherein the gate of the first P-type metal-oxide semiconductor is connected to ground, and the source and drain are separately electrically connected to the pad and the analog circuit IP, and is capable of transmitting a signal that has no influence between the pad and the analog circuit IP.

4. The analog input/output circuit of claim 1 further comprises:
an ESD protection circuit placed between the pad and the transmission gate, and capable of ESD multi-protection.

5. The analog input/output circuit of claim 4, wherein an ESD protection circuit comprises a second N-type metal-oxide semiconductor, and the source and gate are grounded, and the drain is electrically connected to the pad to be capable of discharging the ESD current.

6. The analog input/output circuit of claim 4, wherein an ESD protection circuit comprises a second P-type metal-oxide semiconductor, and the source and gate are biased, and the drain is electrically connected to the pad to be capable of discharging the ESD current.
